(19) United States
(12) Patent Application Publication
(10) Pub. No.: US 2025/0162181 A1
(43) Pub. Date: May 22, 2025

(54) FOLDING KNIFE WITH ADJUSTABLE BLADE UNFOLDING ANGLE AND ADJUSTING METHOD FOR BLADE UNFOLDING ANGLE OF FOLDING KNIFE

(71) Applicant: Zhenglin Chen, Nanning (CN)

(72) Inventor: Zhenglin Chen, Nanning (CN)

(21) Appl. No.: 18/948,381

(22) Filed: Nov. 14, 2024

(30) Foreign Application Priority Data
Nov. 17, 2023 (CN) 202323103609.5

(51) Int. Cl. B26B 1/02; B26B 1/10

(52) U.S. Cl. CPC B26B 1/02; B26B 1/10

(57) ABSTRACT

The present disclosure provides a folding knife with an adjustable blade unfolding angle and an adjusting method for a blade unfolding angle of a folding knife. The folding knife with an adjustable blade unfolding angle includes a knife edge and a knife handle. The folding knife in the present disclosure has a simple and reasonable structure, and a blade unfolding angle can be adjusted by adjusting angles of angle adjustment blocks. When a “sickle” needs to be used in a specific scene, the angle adjustment blocks are rotated towards an inner side of the knife handle by a certain angle to obtain a smaller unfolding angle of the knife edge than a normal angle. The needs for using the knife in specific occasions are met, the functionality and playability of the folding knife are improved, and the angle adjustment is simple.

### CROSS-REFERENCE TO RELATED APPLICATION

This application claims priority of Chinese Patent Application No. 202323103609.5, filed on Nov. 17, 2023, the entire contents of which are incorporated herein by reference.

### TECHNICAL FIELD

The present disclosure belongs to the technical field of folding knives, and particularly relates to a folding knife with an adjustable blade unfolding angle and an adjusting method for a blade unfolding angle of a folding knife.

### BACKGROUND

A folding knife generally includes a knife handle and a blade that can be unfolded and folded relative to the knife handle. The blade or knife handle is mounted with a retaining pin or other blade locking mechanism to allow the blade to be relatively stable in the unfolded and folded states of the folding knife.

As a common tool for people's daily life, the folding knife brings a lot of convenience for people's life. Now the development trend of the folding knife has evolved from not only pursuing practical and powerful performance, but also pursuing functionality and playability.

In daily life and work, it is found that when the conventional folding knife is in use, after the blade is unfolded, an included angle between the blade and the knife handle is fixed, and this angle is predetermined during manufacturing, generally about 180°, leaving no room for user-defined adjustment and positioning. In some usage situations, such folding knife with a fixed larger unfolding angle is less preferred, limiting the application scenarios of conventional folding knives. In cases where the operating space is bent, the functionality of the folding knife is greatly enhanced if an angle between the blade and the knife handle can be bent somewhat like a sickle. Another example is a claw knife currently popular worldwide. If an angle between the knife edge and the knife handle can be adjusted flexibly when playing, the claw knife will be versatile and more interesting.

Based on the problem that the use scenario is limited due to the inconvenient adjustment of the included angle in the existing folding knife, a folding knife with an adjustable blade unfolding angle and an adjusting method for a blade unfolding angle of a folding knife are designed and proposed.

### SUMMARY

To overcome the above technical problems, the present disclosure provides a folding knife with an adjustable blade unfolding angle and an adjusting method for a blade unfolding angle of a folding knife. An angle adjustment block is arranged between a conventional knife edge and a knife handle for connecting and transition, the blade is hingedly mounted to the angle adjustment block, and the unfolding angle of the blade is adjusted by changing an angle of the angle adjustment block relative to the knife handle.

The present disclosure adopts the following technical solutions:

A folding knife with an adjustable blade unfolding angle includes a knife edge and a knife handle. A blade and the knife handle are connected by angle adjustment blocks, the knife edge is hinged to the angle adjustment blocks by a knife shaft, and an angle between the angle adjustment block and the knife handle is adjustable.

In a preferred solution of the present disclosure, the angle adjustment blocks are hinged to the knife handle via a hinge shaft, and the hinge shaft is parallel to the knife shaft.

In a preferred solution of the present disclosure, the hinge shaft of the angle adjustment blocks and the knife handle is located on an inner edge of a front end of the knife handle, the angle adjustment blocks and the knife handle having an overlapping area, the knife handle is arranged with first snaps, and the angle adjustment block has an arc sliding groove, the first snaps and the arc sliding grooves being located in the overlapping area, and an arc of the arc sliding groove being concentric with the hinge shaft; the first snap is located in a notch of the arc sliding groove, and the arc sliding groove has at least two first limit clamping grooves; and when the first snaps are located in different first limit clamping grooves, the angle adjustment blocks and the knife handle have different relative angles.

In a preferred solution of the present disclosure, the first snap is a pressing telescopic snap, and the first limit clamping groove is located on an inner wall of the arc sliding groove; and when the first snap is pressed into the knife handle, the first snap is disengaged from the first limit clamping groove, and an elastic structure is arranged at an interior of the knife handle to maintain a protruding state of the first snap.

In a preferred solution of the present disclosure, the knife handle is divided into lateral handles, medial handles and a tail end block; a front end of the lateral handle is hinged to the angle adjustment blocks, and a rear end of the lateral handle is hinged to the tail end block; a front end of the medial handle is hinged to the angle adjustment blocks, and a rear end of the medial handle is hinged to the tail end block; the angle adjustment blocks, the lateral handle, the tail end block and the medial handle form a quadrilateral structure, and the lateral handle and the medial handle are a set of opposite sides of the quadrilateral; and when the lateral handle and the medial handle are relatively displaced, an angle between the angle adjustment block and the knife handle changes.

In a preferred solution of the present disclosure, the lateral handle has a second clamping head, the medial handle has at least two second limit clamping grooves, and the second limit clamping grooves are distributed along a length direction of the knife handle; and when the second snap is located in a different second limit clamping groove, the lateral handle and the medial handle have different relative positions, and the angle adjustment block and the knife handle have different relative angles.

In a preferred solution of the present disclosure, the second snap is a sliding latch, the second snap is slidably connected to the lateral handle, and the second limit clamping groove is located on an outer edge of the medial handle.

The present disclosure also provides an adjusting method for a blade unfolding angle of a folding knife by using the folding knife with an adjustable blade unfolding angle described above, including the step of: adjusting a relative angle of the angle adjustment block and the knife handle to adjust an unfolding angle of the blade relative to the knife handle.

In a preferred solution of the present disclosure, the angle adjustment block and the knife handle are hinged, the angle adjustment block is rotated with respect to the knife handle, and the relative angle of the angle adjustment block and the knife handle is locked by the first snap on the knife handle cooperating with the first limit clamping groove on the angle adjustment block to adjust an angle of the angle adjustment block and a blade unfolding angle of the folding knife.

In a preferred solution of the present disclosure, the knife handle is a double-layer knife handle, and the knife handle is divided into the lateral handles, the medial handles and the tail end block; the angle adjustment blocks, the lateral handle, the tail end block and the medial handle form the quadrilateral structure, and the lateral handle and the medial handle are a set of opposite sides of the quadrilateral; and the lateral handle and the medial handle are relatively displaced to change an angle of the angle adjustment block with respect to the knife handle, and a relative position of the lateral handle and the medial handle is locked by the second snap on the lateral handle cooperating with the second limit clamping groove on the medial handle to lock the angle of the angle adjustment block, to adjust the angle of the angle adjustment block and the blade unfolding angle of the folding knife.

Compared with the prior art, the present disclosure has the following advantageous effects:
1. In the present disclosure, the angle adjustment blocks are arranged between a conventional knife edge and the knife handle. The angle adjustment block essentially functions as a front end portion of the knife handle, with the knife edge mounted on the angle adjustment block, and the angle of the angle adjustment block relative to the knife handle can be manually adjusted. Once the angle of the angle adjustment block changes, the unfolding angle of the knife edge also changes. The blade unfolding angle can be adjusted by adjusting angles of the angle adjustment blocks. When a “sickle” needs to be used in a specific scene, the angle adjustment blocks are rotated towards an inner side of the knife handle by a certain angle to obtain a smaller unfolding angle of the knife edge than a normal angle, thereby meeting the needs of the knife in specific occasions and improving the functionality and playability of the folding knife.
2. In the present disclosure, two specific implementations are provided, mainly distinguished by the style of the knife handles, followed by the locking manner of the angle adjustment block. The common purpose is to enable an adjustable relative angle between the angle adjustment block and the knife handle. An integrated stable knife handle, which uses a button-snap method to perform angle locking on the angle adjustment block hinged to the knife handle via a single shaft, has a simple and reliable structure, and is convenient and easy to operate. A knife handle with a quadrilateral structure uses the instability of the quadrilateral to adjust the angle of the angle adjustment block as one side of the quadrilateral, and a bolt-type fastener is used to lock the lateral handle and the medial handle, to lock the angle adjustment block. The knife handle with a quadrilateral structure, convenient in adjustment and usage, has a cool structure and higher playability.

### BRIEF DESCRIPTION OF THE DRAWINGS

FIG. 1 is a schematic diagram of Embodiment 1 of the present disclosure;

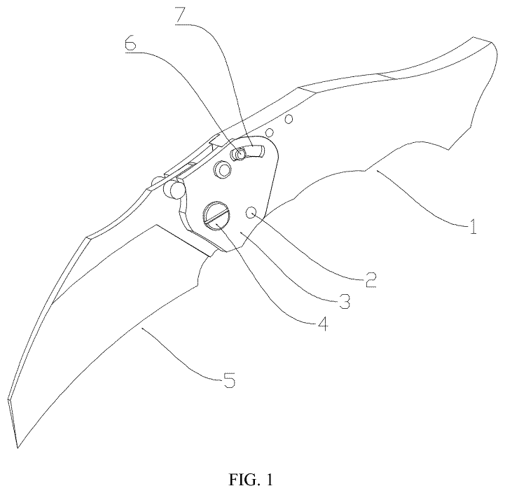

FIG. 2 is a schematic diagram of a remaining structure after removal of a knife handle in FIG. 1;

FIG. 3 is a schematic diagram of an angle adjustment action of Embodiment 1;

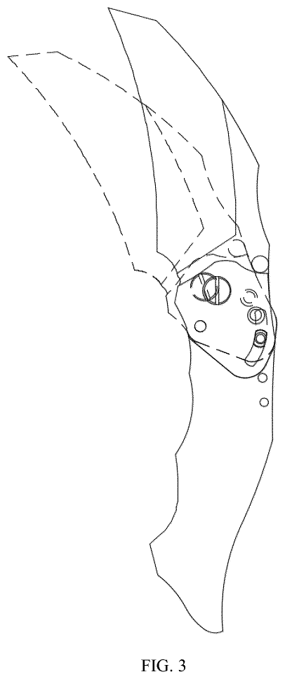

FIG. 4 is a schematic diagram of Embodiment 2 of the present disclosure; and

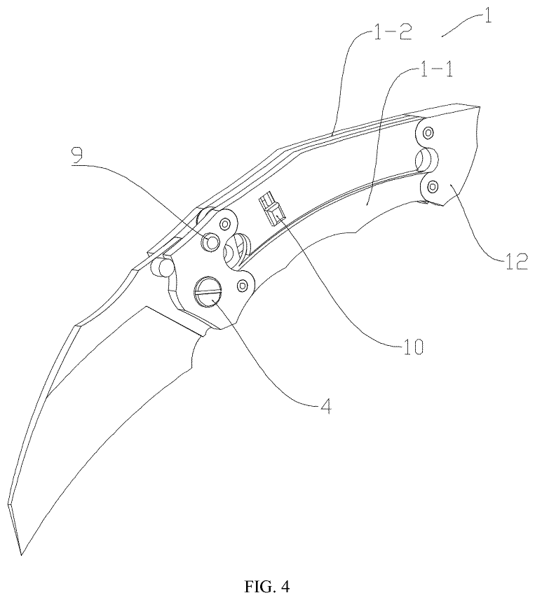

FIG. 5 is a schematic diagram of an internal structure of Embodiment 2 of the present disclosure.

Reference numerals and denotations thereof:

1—knife handle; 1-1—medial handle; 1-2—lateral handle; 2—hinge shaft; 3—angle adjustment block; 4—knife shaft; 5—knife edge; 6—first snap; 7—arc sliding groove; 8—first limit clamping groove; 9—knife lock button; 10—second snap; 11—second limit clamping groove; 12—tail end block; and 13—spring.

### DETAILED DESCRIPTION

Hereinafter, embodiments of the present disclosure will be described in detail, examples of which are shown in the attached drawings. Throughout, the same or similar reference numerals indicate the same or similar elements or elements with the same or similar functions. Unless otherwise specified, the raw materials and equipment used are all commercially available or commonly used in the field, and the methods in the embodiments are all conventional methods in the field. The embodiments described below by referring to the attached drawings are exemplary, and are only for explaining rather than limiting the present disclosure.

### Embodiment 1

A folding knife with an adjustable blade unfolding angle includes a knife edge 5 and a knife handle 1 with a receiving groove. The blade and the knife handle 1 are connected via an angle adjustment block 3, the knife edge 5 is hinged to the angle adjustment block 3 via a knife shaft 4, and an angle demodulator is equivalent to a front end portion of the knife handle 1. An original knife lock button 9 is also arranged on the angle adjustment block 3, and when the knife edge 5 is unfolded, an unfolding limiting rod of the knife edge 5 also is abutted against the angle adjustment block 3. The angle adjustment block 3 is hinged to the knife handle 1 via the hinge shaft 2, and the hinge shaft 2 is parallel to the knife shaft 4, so that the angle between the angle adjustment block 3 and the knife handle 1 can be adjusted. By changing an angle of the angle adjustment block 3, an unfolding angle of the knife edge 5 can be adjusted.

Specifically, the hinge shaft 2 of the angle adjustment blocks 3 and the knife handle 1 is located on an inner edge of a front end of the knife handle 1, the angle adjustment block 3 can swing in a knife retracting direction, and the angle adjustment blocks 3 and the knife handle 1 have an overlapping area. The knife handle 1 is arranged with first snaps 6, the first snap 6 being a pressing telescopic snap embedded on a side surface of the knife handle 1. The angle adjustment block 3 has an arc sliding groove 7, the first snaps 6 and the arc sliding grooves 7 being located in the overlapping area, and an arc of the arc sliding groove 7 being concentric with the hinge shaft 2. The first snap 6 is located in a notch of the arc sliding groove 7, and the arc sliding groove 7 has at least two first limit clamping grooves 8 in an arc. The first limit clamping grooves 8 are located on inner walls of the arc sliding grooves 7, and the first snap 6 is in the shape of a circular rod, an inner end radius thereof being large and an outer end radius thereof being small. A large radius part of the inner end of the first snap 6 is embedded in one of the first limit clamping grooves 8 in an outward protruding state of the first snap 6, to lock the angle of the angle adjustment block 3. When the first snap 6 is pressed into the knife handle 1, the first snap 6 is disengaged from the first limit clamping groove 8, and an elastic structure is arranged inside the knife handle 1 to maintain a protruding state of the first snap 6. When the first snaps 6 are located in different first limit clamping grooves 8, the angle adjustment blocks 3 and the knife handle 1 have different relative angles.

One first snap 6 is arranged on each of two side surfaces of the knife handle 1, the arc sliding groove 7 and the first limit clamping groove 8 are also correspondingly arranged on front and back surfaces, and an elastic structure is specifically a spring 13 located between the two first snaps 6. The spring 13 supports the first snaps 6 on the two sides to protrude outwards at the same time, and the two first snaps 6 are pressed into the knife handle 1 by hand at the same time to release the rotational limit of the first snaps 6 on the angle adjustment blocks 3.

An adjusting method for a blade unfolding angle of a folding knife:
by using the folding knife with an adjustable blade unfolding angle described above, includes the step of: adjusting a relative angle of the angle adjustment block 3 and the knife handle 1 to adjust an unfolding angle of the blade relative to the knife handle 1.

Specifically, two first snaps 6 are pinched and pressed inwards at the same time, so that a thicker section of the first snap 6 is separated from the first limit clamping groove 8, and the locking of the angle adjustment block 3 is released. Since the angle adjustment block 3 and the knife handle 1 are hinged, the angle adjustment block 3 can be rotated relative to the knife handle 1; and after rotating by a certain angle, another first limit clamping groove 8 is aligned with the first snap 6. The fingers are released, so that the first snaps 6 are reset and embedded in the new first limit clamping groove 8 to re-form a clamping connection. The relative angle of the angle adjustment block 3 and the knife handle 1 is locked again, to adjust the angle of the angle adjustment block 3 and the blade unfolding angle of the folding knife.

After the angle adjustment block 3 is rotated and adjusted in a knife retracting direction, an unfolding angle of the knife edge 5 decreases; and after the angle adjustment block 3 is rotated and adjusted in an unfolding direction, an unfolding angle of the knife edge 5 increases.

In the embodiment, the structural design of the present disclosure is only illustrated by the case of two first limit clamping grooves 8. It is easy to think that more first limit clamping grooves 8 can be arranged in order to have more adjustment gears.

### Embodiment 2

A folding knife with an adjustable blade unfolding angle includes a knife edge 5 and a knife handle 1 with a receiving groove. The blade and the knife handle 1 are connected via an angle adjustment block 3, the knife edge 5 is hinged to the angle adjustment block 3 via a knife shaft 4, and an angle demodulator is equivalent to a front end portion of the knife handle 1. An original knife lock button 9 is also arranged on the angle adjustment block 3, and when the knife edge 5 is unfolded, an unfolding limiting rod of the knife edge 5 also is abutted against the angle adjustment block 3. The angle between the angle adjustment block 3 and the knife handle 1 can be adjusted. By changing an angle of the angle adjustment block 3, an unfolding angle of the knife edge 5 can be adjusted.

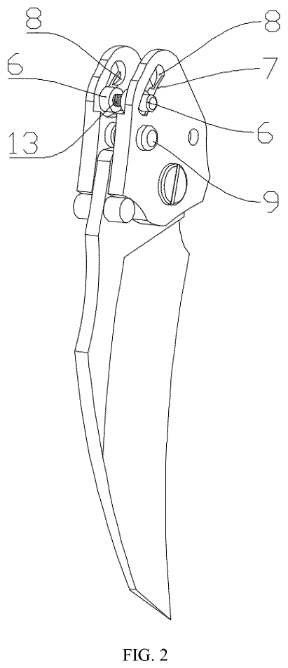

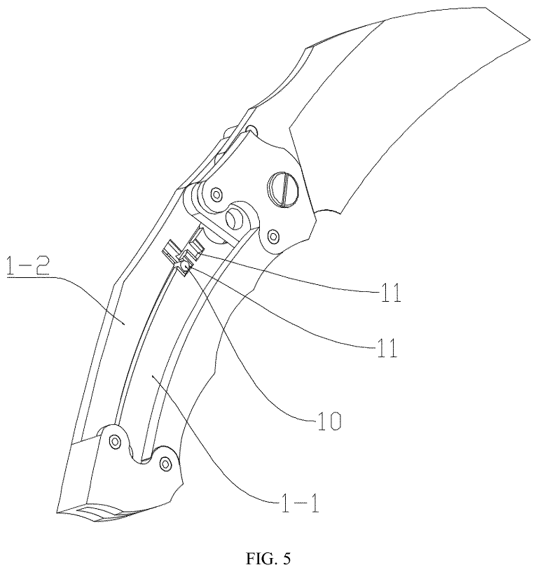

The specific structure is that: the knife handle 1 is divided into lateral handles 1-2, medial handles 1-1 and a tail end block 12; a front end of the lateral handle 1-2 is hinged to the angle adjustment blocks 3, and a rear end of the lateral handle 1-2 is hinged to the tail end block 12; a front end of the medial handle 1-1 is hinged to the angle adjustment blocks 3, and a rear end of the medial handle 1-1 is hinged to the tail end block 12; the angle adjustment blocks 3, the lateral handle 1-2, the tail end block 12 and the medial handle 1-1 form a quadrilateral structure, and the lateral handle 1-2 and the medial handle 1-1 are a set of opposite sides of the quadrilateral, and the angle adjustment block 3 serves as a common adjacent side of the set of opposite sides. With this structure, when the lateral handle 1-2 and the medial handle 1-1 are relatively displaced, the angle between the angle adjustment block 3 and the knife handle 1 can be changed: when the medial handle 1-1 is relatively moved forward and the lateral handle 1-2 is relatively moved backward, the angle adjustment block 3 swings in the unfolding direction; and when the medial handle 1-1 is relatively moved backward and the lateral handle 1-2 is relatively moved forward, the angle adjustment block 3 swings in the knife retracting direction. The lateral handle 1-2 is slidably connected to a latch-type second clamping head, the second snap 10 is slidably connected to the lateral handle 1-2, the second clamping head can be close to the medial handle 1-1 or away from the medial handle 1-1, an outer edge of the medial handle 1-1 overlaps an interior of the lateral handle 1-2, and has two second limit clamping grooves 11, as shown in FIG. 5, and the second limit clamping grooves 11 are distributed along a length direction of the knife handle 1. When the second snap 10 is in a bottom dead point and is located in a different second limit clamping groove 11, the lateral handle 1-2 and the medial handle 1-1 have different relative positions, and the angle adjustment block 3 and the knife handle 1 have different relative angles; and when the second snap 10 is located in the second limit clamping groove 11 at the rear, as shown in the state of FIG. 2, the unfolding angle of the folding knife at this moment is larger, and when the second snap 10 is located in the second limit clamping groove 11 at the front, the unfolding angle of the folding knife is smaller.

An adjusting method for a blade unfolding angle of a folding knife:
by using the folding knife with an adjustable blade unfolding angle of the embodiment, the unfolding angle of the blade relative to the knife handle 1 is adjusted by adjusting the relative angle of the angle adjustment block 3 and the knife handle 1, in a manner different from Embodiment 1.

The second snap 10 is dialed upwards to release the rotational limit of the second snap 10 on the angle adjustment block 3; and since the knife handle 1 is a double-layer knife handle 1, the knife handle 1 is divided into lateral handles 1-2, medial handles 1-1 and a tail end block 12. The angle adjustment blocks 3, the lateral handle 1-2, the tail end block 12 and the medial handle 1-1 form a quadrilateral structure, and at this moment, using the instability of the quadrilateral, the lateral handle 1-2 and the medial handle 1-1 are held to perform relative sliding displacement, thereby changing the angle of the angle adjustment block 3 with respect to the knife handle 1. Finally, the second snap 10 on the lateral handle 1-2 is dialed downwards, so that the second snap 10 cooperates with another second limit clamping groove 11 on the medial handle 1-1 to re-lock the relative positions of the lateral handle 1-2 and the medial handle 1-1, thereby locking the angle of the angle adjustment block 3, and adjusting the angle of the angle adjustment block 3 and adjusting the blade unfolding angle of the folding knife.

After the angle adjustment block 3 is rotated and adjusted in a knife retracting direction, an unfolding angle of the knife edge 5 decreases; and after the angle adjustment block 3 is rotated and adjusted in an unfolding direction, an unfolding angle of the knife edge 5 increases.

In the embodiment, the structural design of the present disclosure is only illustrated by the case of two second limit clamping grooves 11. It is easy to think that more second limit clamping grooves 11 can be arranged in order to have more adjustment gears.

It is to be noted that the above embodiments are only specific and clear descriptions on the technical solutions and technical features of the present application. However, for a person skilled in the art, solutions or features which fall within the prior art or common knowledge are not described in detail in the above embodiments.

In addition, the technical solutions of the present application are not limited to the above embodiments, and a person skilled in the art would have considered the specification as a whole. The technical solutions in the various embodiments can also be combined appropriately to form other implementations which can be understood by a person skilled in the art.

While embodiments of the present disclosure have been shown and described, it will be appreciated by those skilled in the art that many changes, modifications, substitutions and variations can be made to the above embodiments without departing from the principles and spirit of the present disclosure, the scope of which is defined by the claims and equivalents thereof.

1. A folding knife with an adjustable blade unfolding angle, comprising a knife edge (5) and a knife handle (1), wherein a blade and the knife handle (1) are connected by angle adjustment blocks (3), the knife edge (5) is hinged to the angle adjustment blocks (3) by a knife shaft (4), and an angle between the angle adjustment block (3) and the knife handle (1) is adjustable.

2. The folding knife with an adjustable blade unfolding angle according to claim 1, wherein the angle adjustment blocks (3) are hinged to the knife handle (1) via a hinge shaft (2), and the hinge shaft (2) is parallel to the knife shaft (4).

3. The folding knife with an adjustable blade unfolding angle according to claim 2, wherein the hinge shaft (2) of the angle adjustment blocks (3) and the knife handle (1) is located on an inner edge of a front end of the knife handle (1), the angle adjustment blocks (3) and the knife handle (1) having an overlapping area, the knife handle (1) is arranged with first snaps (6), and the angle adjustment block (3) has an arc sliding groove (7), the first snaps (6) and the arc sliding grooves (7) being located in the overlapping area, and an arc of the arc sliding groove (7) being concentric with the hinge shaft (2); the first snap (6) is located in a notch of the arc sliding groove (7), and the arc sliding groove (7) has at least two first limit clamping grooves (8); and when the first snaps (6) are located in different first limit clamping grooves (8), the angle adjustment blocks (3) and the knife handle (1) have different relative angles.

4. The folding knife with an adjustable blade unfolding angle according to claim 3, wherein the first snap (6) is a pressing telescopic snap, and the first limit clamping groove (8) is located on an inner wall of the arc sliding groove (7); and when the first snap (6) is pressed into the knife handle (1), the first snap (6) is disengaged from the first limit clamping groove (8), and an elastic structure is arranged at an interior of the knife handle (1) to maintain a protruding state of the first snap (6).

5. The folding knife with an adjustable blade unfolding angle according to claim 1, wherein the knife handle (1) is divided into lateral handles (1-2), medial handles (1-1) and a tail end block (12); a front end of the lateral handle (1-2) is hinged to the angle adjustment blocks (3), and a rear end of the lateral handle (1-2) is hinged to the tail end block (12); a front end of the medial handle (1-1) is hinged to the angle adjustment blocks (3), and a rear end of the medial handle (1-1) is hinged to the tail end block (12); the angle adjustment blocks (3), the lateral handle (1-2), the tail end block (12) and the medial handle (1-1) form a quadrilateral structure, and the lateral handle (1-2) and the medial handle (1-1) are a set of opposite sides of the quadrilateral; and when the lateral handle (1-2) and the medial handle (1-1) are relatively displaced, an angle between the angle adjustment block (3) and the knife handle (1) changes.

6. The folding knife with an adjustable blade unfolding angle according to claim 5, wherein the lateral handle (1-2) has a second clamping head, the medial handle (1-1) has at least two second limit clamping grooves (11), and the second limit clamping grooves (11) are distributed along a length direction of the knife handle (1); and when the second snap (10) is located in a different second limit clamping groove (11), the lateral handle (1-2) and the medial handle (1-1) have different relative positions, and the angle adjustment block (3) and the knife handle (1) have different relative angles.

7. The folding knife with an adjustable blade unfolding angle according to claim 6, wherein the second snap (10) is a sliding latch, the second snap (10) is slidably connected to the lateral handle (1-2), and the second limit clamping groove (11) is located on an outer edge of the medial handle (1-1).

8. An adjusting method for a blade unfolding angle of a folding knife by using the folding knife with an adjustable blade unfolding angle according to claim 1, further comprising the step of: adjusting a relative angle of the angle adjustment block (3) and the knife handle (1) to adjust an unfolding angle of the blade relative to the knife handle (1).

9. The adjusting method for a blade unfolding angle of a folding knife according to claim 8, wherein the angle adjustment block (3) and the knife handle (1) are hinged, the angle adjustment block (3) is rotated with respect to the knife handle (1), and the relative angle of the angle adjustment block (3) and the knife handle (1) is locked by the first snap (6) on the knife handle (1) cooperating with the first limit clamping groove (8) on the angle adjustment block (3) to adjust an angle of the angle adjustment block (3) and a blade unfolding angle of the folding knife.

10. The adjusting method for a blade unfolding angle of a folding knife according to claim 8, wherein the knife handle (1) is a double-layer knife handle, and the knife handle (1) is divided into the lateral handles (1-2), the medial handles (1-1) and the tail end block (12); the angle adjustment blocks (3), the lateral handle (1-2), the tail end block (12) and the medial handle (1-1) form the quadrilateral structure, and the lateral handle (1-2) and the medial handle (1-1) are a set of opposite sides of the quadrilateral; and the lateral handle (1-2) and the medial handle (1-1) are relatively displaced to change an angle of the angle adjustment block (3) with respect to the knife handle (1), and a relative position of the lateral handle (1-2) and the medial handle (1-1) is locked by the second snap (10) on the lateral handle (1-2) cooperating with the second limit clamping groove (11) on the medial handle (1-1) to lock the angle of the angle adjustment block (3), to adjust the angle of the angle adjustment block (3) and the blade unfolding angle of the folding knife.
